(19) United States
(12) Patent Application Publication
(10) Pub. No.: US 2019/0131837 A1
(43) Pub. Date: May 2, 2019

(54) ROTOR

(71) Applicant: AISIN AW CO., LTD., Anjo-shi, Aichi-ken (JP)

(72) Inventors: Tsuyoshi MIYAJI, Anjo (JP); Naoto SAITO, Anjo (JP)

(73) Assignee: AISIN AW CO., LTD., Anjo-shi, Aichi-ken (JP)

(21) Appl. No.: 16/089,068

(22) PCT Filed: Jun. 2, 2017
(86) PCT No.: PCT/JP2017/020718

§ 371 Date: Sep. 27, 2018

(30) Foreign Application Priority Data
Jun. 3, 2016 (JP) 2016-112000

(51) Int. Cl. H02K 1/27

(52) U.S. Cl. CPC H02K 1/2766

(57) ABSTRACT

A rotor that includes a rotor core having a plurality of electrical steel sheets stacked in an axial direction; and a permanent magnet embedded in the rotor core and disposed so as to face a stator, wherein: the electrical steel sheet has a magnet insertion hole in which the permanent magnet is inserted and a positioning protrusion protruding along a non-pole face of the permanent magnet into the magnet insertion hole, and in at least a part of the plurality of electrical steel sheets, the positioning protrusion is harder than a general portion that is a portion other than the positioning protrusion.

### BACKGROUND

The present disclosure relates to rotors for use in, e.g., rotating electrical machines.

Rotating electrical machines that are used as driving force sources for wheels in, e.g., hybrid vehicles, electric vehicles, etc. often use an interior permanent magnet rotor for reduced size, increased rotational speed, reduced weight, etc. Japanese Patent Application Publication No. 2006-50821 (JP 2006-50821 A) discloses that, in order to reduce leakage flux and increase torque in such a rotor, outer peripheral bridge portions [bridge portions 62] located radially outside magnet insertion holes in which permanent magnets are inserted are made thinner than other portions. In the rotor of JP 2006-50821 A, each permanent magnet is positioned in the magnet insertion hole by positioning protrusions [protrusions having a wall surface 40a, 40b] that protrude along non-pole faces of the permanent magnet.

JP 2006-50821 A mentions that inter-hole bridge portions each formed between two magnet insertion holes [inner bridge portions each formed between a pair of inner extended portions 37; paragraph 0039] may be made thinner than other portions in order to reduce leakage flux and increase torque. However, JP 2006-50821 A mentions only the outer peripheral bridge portions and the inter-hole bridge portions as the portions to be made thinner. If it is found that there is any portion other than the outer peripheral bridge portions and the inter-hole bridge portions which causes leakage flux, leakage flux is further reduced and torque is further increased by performing an appropriate process on this portion. In this sense, the technique of JP 2006-50821 A has room for improvement in terms of reduction in leakage flux.

### SUMMARY

It is desired to reduce leakage flux and increase torque in interior permanent magnet rotors by a method different from conventional methods.

A rotor according to the present disclosure is a rotor that includes a rotor core having a plurality of electrical steel sheets stacked in an axial direction and a permanent magnet embedded in the rotor core and that is disposed so as to face a stator, wherein the electrical steel sheet has a magnet insertion hole in which the permanent magnet is inserted and a positioning protrusion protruding along a non-pole face of the permanent magnet into the magnet insertion hole, and in at least a part of the plurality of electrical steel sheets, the positioning protrusion is harder than a general portion that is a portion other than the positioning protrusion.

Inventors' research shows that, in the case where an electrical steel sheet has a positioning protrusion protruding along a non-pole face of a permanent magnet into a magnet insertion hole, the positioning protrusion may also cause leakage flux. Based on this knowledge, magnetic resistance can be increased in the positioning protrusion by making the positioning protrusion harder than the general portion, namely the portion other than the positioning protrusion, in at least a part of the plurality of electrical steel sheets as described above. Leakage flux is thus reduced and effective magnetic flux is increased, whereby an increase in torque is achieved.

Further features and advantages of the technique of the present disclosure will become more apparent from the following description of illustrative and nonrestrictive embodiments which is given with reference to the accompanying drawings.

### BRIEF DESCRIPTION OF THE DRAWINGS

FIG. 1 is a perspective view of a rotor according to an embodiment.

FIG. 2 is a plan view of an electrical steel sheet for a single magnetic pole.

FIG. 3 is a schematic view of a portion around magnet insertion holes in an electrical steel sheet in a middle region.

FIG. 4 is a sectional view taken along line IV-IV in FIG. 3.

FIG. 5 is a sectional view taken along line V-V in FIG. 3.

FIG. 6 is a schematic view of a portion around magnet insertion holes in an electrical steel sheet in an end region.

FIG. 7 is a sectional view taken along line VII-VII in FIG. 6.

FIG. 8 is a sectional view taken along line VIII-VIII in FIG. 6.

FIG. 9 is a schematic view of a portion around magnet insertion holes in an electrical steel sheet according to another embodiment.

FIG. 10 is a schematic view of a portion around magnet insertion holes in an electrical steel sheet according to still another embodiment.

FIG. 11 is a schematic view of a portion around magnet insertion holes in an electrical steel sheet according to yet another embodiment.

FIG. 12 is a view showing how electrical steel sheets are stacked in a rotor according to a further embodiment.

FIG. 13 is a view showing how electrical steel sheets are stacked in a rotor according to the further embodiment.

FIG. 14 is a sectional view of an electrical steel sheet according to a still further embodiment.

FIG. 15 is a sectional view of an electrical steel sheet according to a yet further embodiment.

### DETAILED DESCRIPTION OF EMBODIMENTS

Embodiments of a rotor will be described with reference to the accompanying drawings. A rotor 1 of an embodiment is included in a rotating electrical machine that is used as a driving force source for wheels in, e.g., hybrid vehicles, electric vehicles, etc. The rotating electrical machine includes a stator fixed to a non-rotary member such as a case, and the rotor 1 rotatably supported radially inside the stator. The stator includes a stator core and a coil wound in the stator core. The rotor 1 serving as a field is rotated by a magnetic field that is generated from the stator.

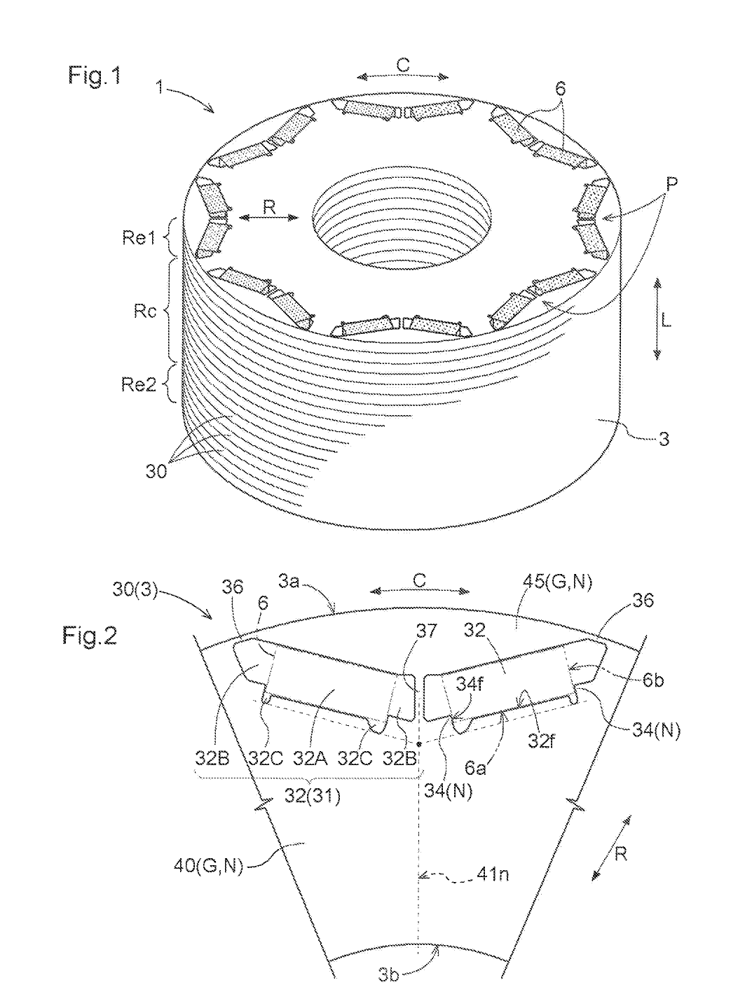

As shown in FIG. 1, the rotor 1 that is disposed so as to face a stator (not shown) includes a rotor core 3 and permanent magnets 6 embedded in the rotor core 3. That is, the rotor 1 of the present embodiment is formed as an interior permanent magnet rotor. Such an interior permanent magnet rotor 1 is preferably used in order to achieve reduction in size, an increase in rotational speed, reduction in weight, etc. as the rotor 1 can use reluctance torque in addition to magnet torque.

The rotor core 3 has a plurality of electrical steel sheets 30 stacked in the axial direction L. The electrical steel sheets 30 have the shape of an annular disc. A large part of each electrical steel sheet 30 has a reference thickness T0 (see FIG. 7 etc.). The reference thickness T0 is, e.g., 0.1 mm to 0.5 mm and is typically about 0.35 mm. The rotor core 3 of the present embodiment is divided into three axial regions, namely a first end region Re1, a middle region Rc, and a second end region Re2 from one side in the axial direction L. Each of the first end region Re1 and the second end region Re2 is set as a region having an axial length that is, e.g., about 1/100 to ⅕ of the entire axial length of the rotor core 3. In the present embodiment, the electrical steel sheets 30 in the first end region Re1 and the electrical steel sheets 30 in the second end region Re2 have the same three-dimensional shape, and the electrical steel sheets 30 in the middle region Rc have a different three-dimensional shape from the electrical steel sheets 30 in each end region Re1, Re2. This will be described later.

The permanent magnets 6 are embedded in the rotor core 3 so as to extend through the rotor core 3 in the axial direction L. As shown by phantom lines in FIG. 2, the sectional shape in a plane perpendicular to the axial direction L (hereinafter simply referred to as the “sectional shape”) of the permanent magnet 6 of the present embodiment is a rectangle. Each magnetic pole P is formed by a pair of permanent magnets 6 arranged next to each other in the circumferential direction C in a V-shape projecting radially inward.

A pair of permanent magnets 6 forming each magnetic pole P are arranged such that their pole faces 6a of the same polarity (N pole or S pole) face radially outward. Two magnetic poles P adjacent to each other in the circumferential direction C have opposite polarities, and a pair of permanent magnets 6 of one magnetic pole P and a pair of permanent magnets 6 of the other magnetic pole P are arranged such that their pole faces 6a of different polarities (N pole/S pole) face radially outward.

The pole faces 6a are outer surfaces perpendicular to the magnetization direction (magnetizing direction) and are surfaces through which magnetic flux of the permanent magnets 6 mainly enters or leaves the permanent magnets 6. In the present embodiment, the permanent magnets 6 having a rectangular sectional shape have been magnetized in a direction parallel to their shorter sides. Accordingly, in the present embodiment, two surfaces forming the longer sides of the rectangle out of the outer peripheral surfaces (four surfaces forming the outer periphery of a section perpendicular to the axial direction L) of each permanent magnet 6 are pole faces 6a. In the present embodiment, the remaining two surfaces (outer surfaces parallel to the magnetization direction; in the present embodiment, two surfaces forming the shorter sides of the rectangle) of the outer peripheral surfaces of each permanent magnet 6 are referred to as non-pole faces 6b. The pair of pole faces 6a are parallel to each other, and the pair of non-pole faces 6b are also parallel to each other. In this example, the pole faces 6a meet the non-pole faces 6b at right angles.

As shown in FIGS. 1 and 2, the electrical steel sheets 30 have a plurality of holes 31 in each magnetic pole P. The holes 31 include at least magnet insertion holes 32 in which the permanent magnets 6 are inserted. In the present embodiment, since each magnetic pole P is formed by a pair of permanent magnets 6, the electrical steel sheets 30 have in each magnetic pole P a plurality of holes 31 including at least two magnet insertion holes 32. In each magnetic pole P, a pair of magnet insertion holes 32 are arranged in a V-shape projecting radially inward. Each magnet insertion hole 32 of the present embodiment includes a magnet accommodating portion 32A and extended barrier portions 32B. The magnet accommodating portion 32A is a portion accommodating and holding the permanent magnet 6 therein.

The extended barrier portions 32B are portions functioning as magnetic resistance (flux barrier) to magnetic flux flowing in the rotor core 3. The extended barrier portions 32B also function as portions that are filled with, e.g., a resin, an adhesive, etc. (hereinafter simply referred to as a “resin etc.”) in order to fix the permanent magnet 6 in the magnet insertion hole 32 with the resin etc. The extended barrier portions 32B are formed at both ends of the magnet accommodating portion 32A so as to be continuous with the magnet accommodating portion 32A in the longitudinal direction of the magnet accommodating portion 32A (approximately in the circumferential direction C of the rotor 1).

The electrical steel sheets 30 have, in the magnet insertion holes 32 (in particular, the extended barrier portions 32B formed at both ends in this example), positioning protrusions 34 for positioning the permanent magnets 6. The positioning protrusions 34 protrude along the non-pole faces 6b of the permanent magnets 6. The positioning protrusions 34 are formed so as to have a triangular sectional shape. The positioning protrusions 34 are formed so as to protrude into the magnet insertion holes 32 beyond the pole faces 6a of the permanent magnets 6 (or opposing surfaces 32f of the magnet insertion holes 32 which face the pole faces 6a of the permanent magnets 6; see FIG. 3). In other words, the positioning protrusions 34 are formed so as to protrude into a region sandwiched between imaginary lines extended from ends of the pair of pole faces 6a in a tangential direction to each pole face 6a, when the electrical steel sheets 30 are viewed in the axial direction L. In the case where the permanent magnets 6 have a rectangular shape as in the present embodiment, the positioning protrusions 34 are formed so as to protrude between a pair of imaginary lines extended along the pole faces 6a of the permanent magnets 6.

Each positioning protrusion 34 is formed so that its one surface (opposing surface 34f) faces the non-pole face 6b of the permanent magnet 6 either in surface contact therewith or with small clearance therebetween. A pair of positioning protrusions 34 are formed in each magnet insertion hole 32 so that their opposing surfaces 34f are separated from each other by a distance corresponding to the length of the permanent magnet 6. The permanent magnet 6 is thus positioned in the magnet insertion hole 32 by the pair of positioning protrusions 34.

Each magnet insertion hole 32 of the present embodiment further includes relief holes 32C. The relief holes 32C are formed at both ends of the magnet accommodating portion 32A so as to be continuous with the magnet accommodating portion 32A in the lateral direction of the magnet accommodating portion 32A (approximately toward the inside of the rotor 1 in the radial direction). The relief holes 32C are provided in order to prevent the corners of the permanent magnet 6 from hitting the magnet accommodating portion 32A during insertion of the permanent magnet 6 into the magnet accommodating portion 32A and to prevent stress concentration on the corners of the permanent magnets 6 after insertion of the permanent magnets 6 into the magnet accommodating portion 32A. The presence of the relief holes 32C is also advantageous because it improves filling of the magnet insertion holes 32 with a resin etc.

The electrical steel sheets 30 have outer peripheral bridge portions 36 and an inter-hole bridge portion 37 in each magnetic pole P. Each outer peripheral bridge portion 36 is formed between one of the holes 31 and an outer peripheral surface 3a of the rotor core 3. In the present embodiment, each outer peripheral bridge portion 36 is formed between the magnet insertion hole 32 (in particular, the radially outer extended barrier portion 32B in this example) and the outer peripheral surface 3a of the rotor core 3. Each outer peripheral bridge portion 36 extends in the circumferential direction C to bridge an end of an inner magnetic path formation portion 40 in the circumferential direction C and an end of an outer magnetic path formation portion 45 in the circumferential direction C. In the present embodiment, the outer peripheral surface 3a of the rotor core 3 corresponds to the “stator opposing surface,” and the outer peripheral bridge portion 36 corresponds to the “stator-side bridge portion.”

The inter-hole bridge portion 37 is formed between two holes 31 adjacent to each other in the circumferential direction C. In the present embodiment, the inter-hole bridge portion 37 is formed between two magnet insertion holes 32 (in particular, radially inner extended barrier portions 32B in this example) adjacent to each other in the circumferential direction C. The inter-hole bridge portion 37 extends in the radial direction R to bridge a middle part of the inner magnetic path formation portion 40 in the circumferential direction C and a middle part of the outer magnetic path formation portion 45 in the circumferential direction C.

The electrical steel sheets 30 have an inner magnetic path formation portion 40 and an outer magnetic path formation portion 45 in each magnetic pole P. The inner magnetic path formation portion 40 is formed so as to extend along the pole faces 6a of the permanent magnets 6. The inner magnetic path formation portion 40 is formed radially inside the magnet insertion holes 32 so as to extend along the pole faces 6a of the pair of permanent magnets 6 arranged in a V-shape. In the present embodiment, the inner magnetic path formation portion 40 corresponds to the “magnetic path formation portion.” The inner magnetic path formation portion 40 mainly serves as a path for magnetic flux (what is called q-axis flux) flowing along the pole faces 6a of the permanent magnets 6.

The inner magnetic path formation portion 40 includes a primary magnetic path region 41 and a secondary magnetic path region 42. The primary magnetic path region 41 is a region defined by a part (smallest width portion 41n) of the inner magnetic path formation portion 40, and the part has the smallest magnetic path width (width in a direction perpendicularly crossing the pole face 6a). Specifically, the primary magnetic path region 41 is a strip-shaped region having the same width as the smallest width portion 41n and extending along the pole faces 6a. The primary magnetic path region 41 is formed in the shape of a strip with a constant width so as to extend along the pole faces 6a of the pair of permanent magnets 6 arranged in a V-shape.

The smallest width portion 41n is typically formed between a line of intersection of imaginary planes, each parallel to the pole faces 6a of a corresponding one of the permanent magnets 6 and contacting the bottoms of the relief holes 32C that are included in a corresponding one of the pair of magnet insertion holes 32 and are located radially inside the pole faces 6a of the corresponding permanent magnet 6, and an inner peripheral surface 3b of the rotor core 3. The smallest width portion 41n is usually located in a middle part of each magnetic pole P in the circumferential direction C. In this case, the width of the smallest width portion 41n is approximately the radial width between the line of intersection of the imaginary planes and the inner peripheral surface 3b of the rotor core 3. The term “perpendicularly” means either a perpendicular state or a substantially perpendicular state (e.g., within ±5° with respect to the perpendicular state).

The secondary magnetic path region 42 is a region that is included in a portion having a larger magnetic path width than the smallest width portion 41n and that is located closer to the magnet insertion holes 32 than the primary magnetic path region 41 is. As described above, the primary magnetic path region 41 is defined by the smallest width portion 41n, and the smallest width portion 41n is determined based on the relief holes 32C. The secondary magnetic path region 42 is therefore a region that is located radially inside the magnet insertion holes 32 and radially outside the imaginary planes each parallel to the pole faces 6a of the permanent magnet 6 and contacting the bottoms of the relief holes 32C located radially inside the pole faces 6a of the permanent magnet 6. The secondary magnetic path region 42 is a deformed region extending along the pole faces 6a of the pair of permanent magnets 6 arranged in a V-shape and conforming to the shapes of the relief holes 32C and the positioning protrusions 34.

The outer magnetic path formation portion 45 is formed so as to extend in the circumferential direction C between the pair of permanent magnets 6 and the outer peripheral surface 3a of the rotor core 3. The outer magnetic path formation portion 45 mainly serves as a path for magnetic flux (what is called d-axis flux) flowing in the magnetization direction of the permanent magnets 6.

As described above, the electrical steel sheets 30 have, as a substantial portion excluding the holes 31 (magnet insertion holes 32) that are formed as openings, the positioning protrusions 34, the outer peripheral bridge portions 36, the inter-hole bridge portion 37, the inner magnetic path formation portion 40, and the outer magnetic path formation portion 45 in each magnetic pole P. In the present embodiment, of these portions, the portions other than the outer peripheral bridge portions 36 and the inter-hole bridge portion 37 (the positioning protrusions 34, the inner magnetic path formation portion 40, and the outer magnetic path formation portion 45) are referred to as a non-bridge portion N. Of the non-bridge portion N (the portions other than the outer peripheral bridge portions 36 and the inter-hole bridge portion 37), a portion other than the positioning protrusions 34 (the inner magnetic path formation portion 40 and the outer magnetic path formation portion 45; excluding a part of the secondary magnetic path region 42 of the inner magnetic path formation portion 40) is referred to as a general portion G. Although the non-bridge portion N and the general portion G are slightly different from each other depending on whether they include the positioning protrusions 34 and a part of the secondary magnetic path region 42 or not, the non-bridge portion N and the general portion G are concepts that can be considered to be substantially the same.

Since the rotor core 3 has a plurality of magnetic poles P, the electrical steel sheets 30 have a plurality of positioning protrusions 34, a plurality of outer 10 peripheral bridge portions 36, a plurality of inter-hole bridge portions 37, a plurality of inner magnetic path formation portions 40, and a plurality of outer magnetic path formation portions 45. The plurality of inner magnetic path formation portions 40 are substantially combined together in the circumferential direction C and have an annular overall shape.

In the present embodiment, as shown in FIG. 3, at least a part of the plurality of inter-hole bridge portions 37 is made harder than the non-bridge portion N (in particular, the general portion G in this example) in a part of the electrical steel sheets 30. Regions that are made harder than the non-bridge portion N (general portion G) are shown hatched in FIG. 3. In the present embodiment, at least a part of the plurality of inter-hole bridge portions 37 is made harder than the general portion G in the electrical steel sheets 30 in the middle region Rc (see FIG. 1) of the rotor core 3. In the present embodiment, the electrical steel sheets 30 have a single inter-hole bridge portion 37 in each magnetic pole P, and in all of the magnetic poles P, at least a part of the inter-hole bridge portion 37 is made harder than the general portion G. That is, all of the plurality of inter-hole bridge portions 37 formed in the electrical steel sheets 30 are made harder than the general portion G.

Each inter-hole bridge portion 37 is entirely made harder than the general portion G. That is, each inter-hole bridge portion 37 is made harder than the general portion G in the entire region (entire region in both the radial direction R and the circumferential direction C) between two holes 31 (magnet insertion holes 32) adjacent to each other in the circumferential direction C.

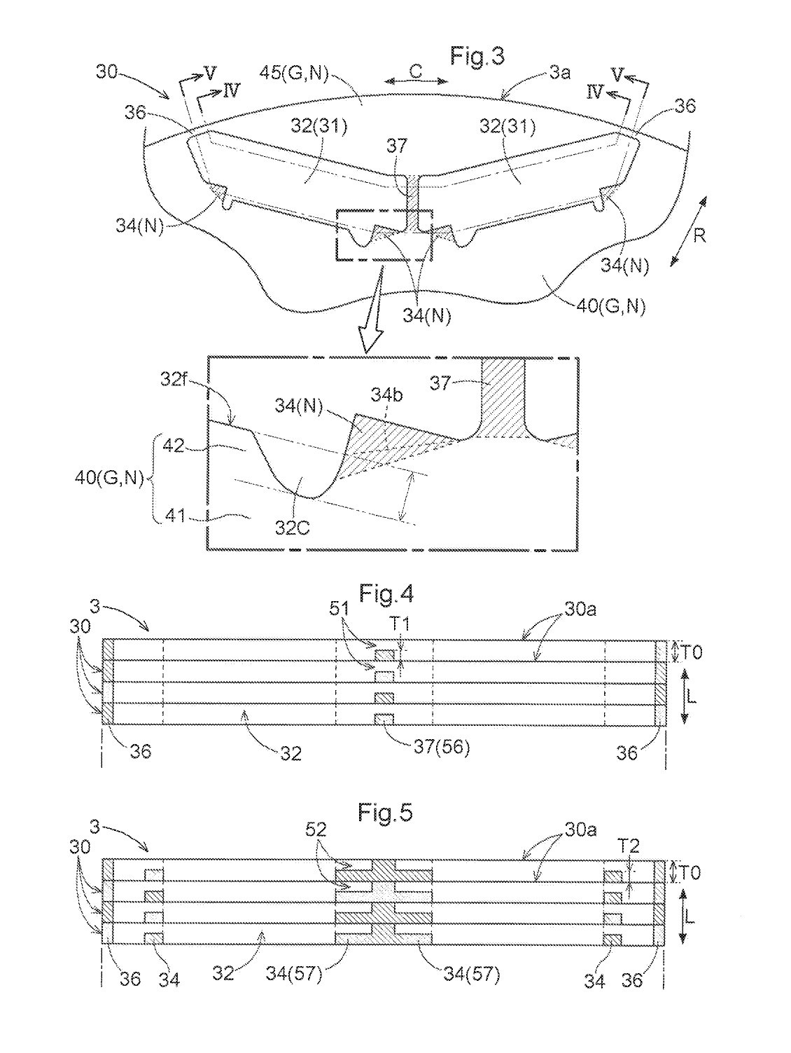

The inter-hole bridge portions 37 of the electrical steel sheets 30 in the middle region Rc are made thinner than the general portion G by an amount corresponding to the depth of a first recess 51 by forming first recesses 51 at predetermined positions in a first principal surface 30a, namely a surface on one side in the axial direction L of the electrical steel sheet 30 (see FIG. 4). The first recesses 51 can be formed by, e.g., machining such as pressing. That is, the first recesses 51 are formed in the electrical steel sheet 30 with the reference thickness T0 by compressing the predetermined positions of the electrical steel sheet 30 in the axial direction L, whereby first thinner portions 56 with a first thickness T1 smaller than the reference thickness T0 appear at the positions where the first recesses 51 have been formed. The first thinner portions 56 have higher hardness as the electrical steel sheet 30 with the reference thickness T0 is compressed in the axial direction L. The inter-hole bridge portions 37 that are harder and thinner than the general portion G are thus formed by the first thinner portions 56. The hardness of the inter-hole bridge portions 37 may be, e.g., about 1.05 to 2.5 times that of the general portion G, and the first thickness T1 may be, e.g., about 40% to 95% of the reference thickness T0.

The outer peripheral bridge portions 36 have the same hardness as the non-bridge portion N (in particular, the general portion G in this example). That is, unlike the inter-hole bridge portions 37, the outer peripheral bridge portions 36 are not made harder than the general portion G. Regarding the thickness, the outer peripheral bridge portions 36 have the same thickness as the non-bridge portion N (general portion G), and unlike the inter-hole bridge portions 37, are not made thinner than the general portion G. The outer peripheral bridge portions 36 are formed so as to have the thickness (reference thickness T0) of the electrical steel sheets 30 themselves (see FIG. 4).

As shown in FIG. 3, the positioning protrusions 34 are made harder than the general portion G in a part of the electrical steel sheets 30. In the present embodiment, the positioning protrusions 34 are made harder than the general portion G in the electrical steel sheets 30 in the middle region Rc of the rotor core 3. In the present embodiment, all of the positioning protrusions 34 are made harder than the general portion G. Moreover, each positioning protrusion 34 is entirely made harder than the general portion G. Regarding the thickness, all of the positioning protrusions 34 are entirely made thinner than the general portion G in the electrical steel sheets 30 in the middle region Rc of the rotor core 3.

In the present embodiment, in addition to the positioning protrusions 34, parts of the secondary magnetic path region 42 which are continuous with bases 34b of the positioning protrusions 34 are made harder than the general portion G. In other words, the region that is made harder than the general portion G not only includes the positioning protrusions 34 but also is extended, beyond imaginary extended lines of the pole faces 6a of the permanent magnets 6 or the opposing surfaces 32f facing the pole faces 6a, to include a part of the secondary magnetic path region 42 located radially inside the positioning protrusions 34. This higher hardness region does not extend to the primary magnetic path region 41.

The positioning protrusions 34 of the electrical steel sheets 30 in the middle region Rc are made thinner than the general portion G by an amount corresponding to the depth of a second recess 52 by, e.g., forming second recesses 52 at predetermined positions in the first principal surface 30a of the electrical steel sheet 30 (see FIG. 5). Like the first recesses 51, the second recesses 52 can be formed by, e.g., machining such as pressing. The second recesses 52 may be formed either simultaneously with the first recesses 51 or separately from the first recesses 51. The second recesses 52 are formed in the electrical steel sheet 30 with the reference thickness T0 by compressing the predetermined positions of the electrical steel sheet 30 in the axial direction L, whereby second thinner portions 57 with a second thickness T2 smaller than the reference thickness T0 appear at the positions where the second recesses 52 have been formed. The second thinner portions 57 have higher hardness as the electrical steel sheet 30 with the reference thickness T0 is compressed in the axial direction L. The positioning protrusions 34 that are harder and thinner than the general portion G are thus formed by the second thinner portions 57. The hardness of the positioning protrusions 34 may be, e.g., about 1.05 to 2.5 times that of the general portion C, and the second thickness T2 may be, e.g., about 40% to 95% of the reference thickness T0.

The hardness of the positioning protrusions 34 may be either the same as or different from that of the inter-hole bridge portions 37. The second thickness T2 of the second thinner portions 57 may be either the same as or different from the first thickness T1 of the first thinner portions 56. In the present embodiment, an example in which the first thickness T1 is the same as the second thickness T2 and the positioning protrusions 34 and the inter-hole bridge portions 37 have the same hardness (and a thickness that is about 50% of the reference thickness T0) is shown in the figures.

The magnet insertion holes 32 may be punched either after formation of the first recesses 51 and the second recesses 52 or before formation of the first recesses 51 and the second recesses 52. Alternatively, the magnet insertion holes 32 may be punched simultaneously with formation of the first recesses 51 and the second recesses 52.

As shown in FIGS. 4 and 5, the electrical steel sheets 30 in the middle region Rc are stacked such that the first recesses 51 and the second recesses 52 face the same side in the axial direction L. In the case where the electrical steel sheets 30 are stacked in this manner, a stack of the electrical steel sheets 30 can be easily formed by merely successively forming the electrical steel sheets 30 having the first recesses 51 and the second recesses 52 by, e.g., machining and sequentially stacking these electrical steel sheets 30 as they are.

As described above, in the present embodiment, in the electrical steel sheets 30 in the middle region Rc, the inter-hole bridge portions 37 and the positioning protrusions 34 are made harder than the general portion G, whereas the outer peripheral bridge portions 36 have the same hardness as the general portion G. Regarding the thickness, in the electrical steel sheets 30 in the middle region Rc, the inter-hole bridge portions 37 and the positioning protrusions 34 are made thinner than the general portion G, whereas the outer peripheral bridge portions 36 have the same thickness as the general portion G.

Most of magnetic flux having left the permanent magnets 6 concentrates on the centers of the magnetic poles P (what is called the d-axis direction) and flows into the stator, but some of the magnetic flux is leakage flux flowing through the inter-hole bridge portions 37. Although the extended barrier portions 32B are formed on both sides of each permanent magnet 6, the inventors found that, in the case where the positioning protrusions 34 are formed so as to protrude into the extended barrier portions 32B, there may be leakage flux flowing through the extended barrier portions 32B and the positioning protrusions 34. The possibility of the presence of leakage flux due to the presence of the positioning protrusions 34 is a new knowledge obtained through inventors' rigorous research. In view of these, in the present embodiment, the inter-hole bridge portions 37 and the positioning protrusions 34 are made harder than the general portion G and the inter-hole bridge portions 37 and the positioning protrusions 34 are made thinner than the general portion G.

In the case where the inter-hole bridge portions 37 and the positioning protrusions 34 are formed by compressing the corresponding portions of the electrical steel sheet 30 by, e.g., pressing etc., residual stress remains in these portions having higher hardness, and magnetic properties are degraded due to the residual stress. Since the thickness of the inter-hole bridge portions 37 and the thickness of the positioning protrusions 34 are also reduced at this time, the magnetic path sectional area is reduced and magnetic resistance is increased in these portions, whereby leakage flux is reduced. Significant reduction in leakage flux is thus achieved by the increased hardness and reduced thickness of these portions. As a result, effective magnetic flux flowing toward the stator is increased, whereby an increase in torque is achieved.

It is conventionally well known in the art that some of magnetic flux having left the permanent magnets 6 is leakage flux flowing through the outer peripheral bridge portions 36. Accordingly, in order to merely further reduce leakage flux, the outer peripheral bridge portions 36 can also be made harder (thinner) like the inter-hole bridge portions 37 and the positioning protrusions 34. In the present embodiment, however, the outer peripheral bridge portions 36 have the same hardness and thickness as the general portion G.

If the outer peripheral bridge portions 36 are formed by compressing the corresponding portions of the electrical steel sheet 30 by, e.g., pressing etc., residual stress remains in these portions, and such residual stress increases hysteresis loss. This results in an increase in iron loss. In particular, since loss near the surface of the rotor 1 is dominant in iron loss, an increase in hysteresis loss in the outer peripheral bridge portions 36 located adjacent to the outer peripheral surface 3a of the rotor core 3 significantly affects an increase in iron loss. Moreover, cogging torque and torque ripple may increase, producing noise and vibration. In view of these, in the present embodiment, the outer peripheral bridge portions 36 are not made harder than the general portion G but have the same hardness as the general portion G, and are not made thinner than the general portion G but have the same thickness as the general portion G. This restrains an increase in iron loss and production of noise and vibration.

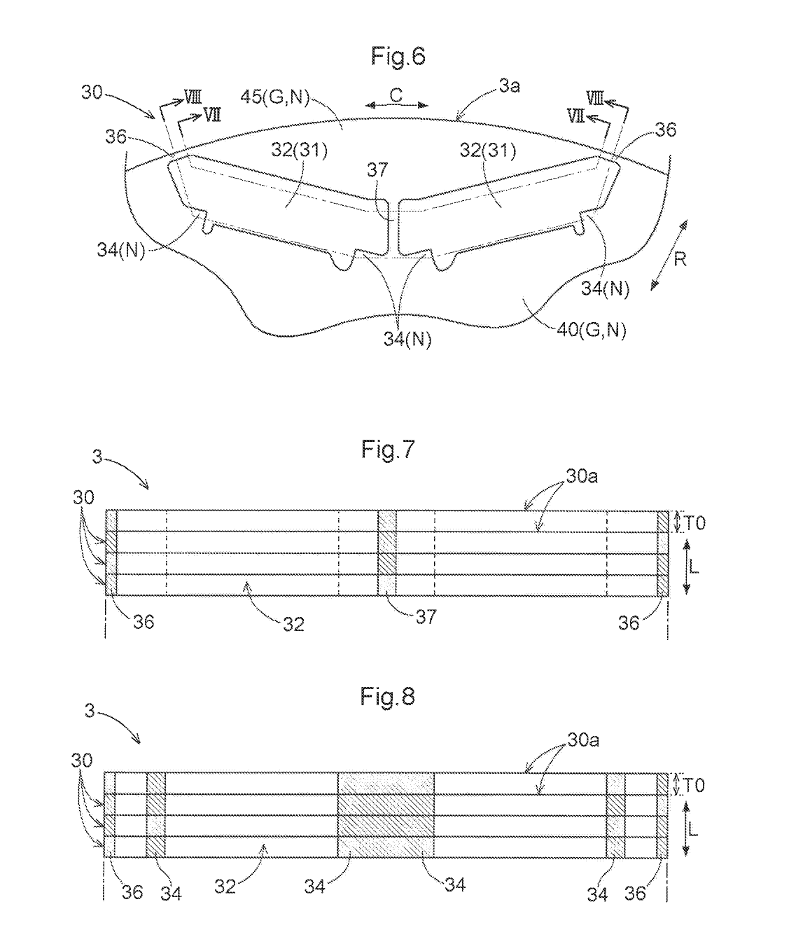

On the other hand, in the electrical steel sheets 30 in the first end region Re1 or the second end region Re2 (see FIG. 1) of the rotor core 3, as shown in FIGS. 6 to 8, not only the outer peripheral bridge portions 36 but also the inter-hole bridge portions 37 and the positioning protrusions 34 have the same hardness and thickness as the general portion G. In order to merely minimize leakage flux in each electrical steel sheet 30, the inter-hole bridge portions 37 and the positioning protrusions 34 can be made harder and thinner in all the electrical steel sheets 30 forming the rotor core 3. However, the inventors found that, even in such a configuration, magnetic flux that no longer leaks through the inter-hole bridge portions 37 etc. may not necessarily flow toward the stator as effective magnetic flux but may leak in the axial direction L near both ends of the rotor core 3. The possibility that the magnetic flux that no longer leaks through the inter-hole bridge portions 37 etc. may leak in the axial direction L is a new knowledge obtained through inventor's rigorous research.

In view of this, in the present embodiment, all the portions including the inter-hole bridge portions 37 and the positioning protrusions 34 have the same hardness and thickness in the electrical steel sheets 30 in the first end region Re1 or the second end region Re2 of the rotor core 3. This reduces leakage flux in the axial direction L and increases the overall effective magnetic flux of the rotor 1, thereby achieving a further increase in torque.

### Other Embodiments

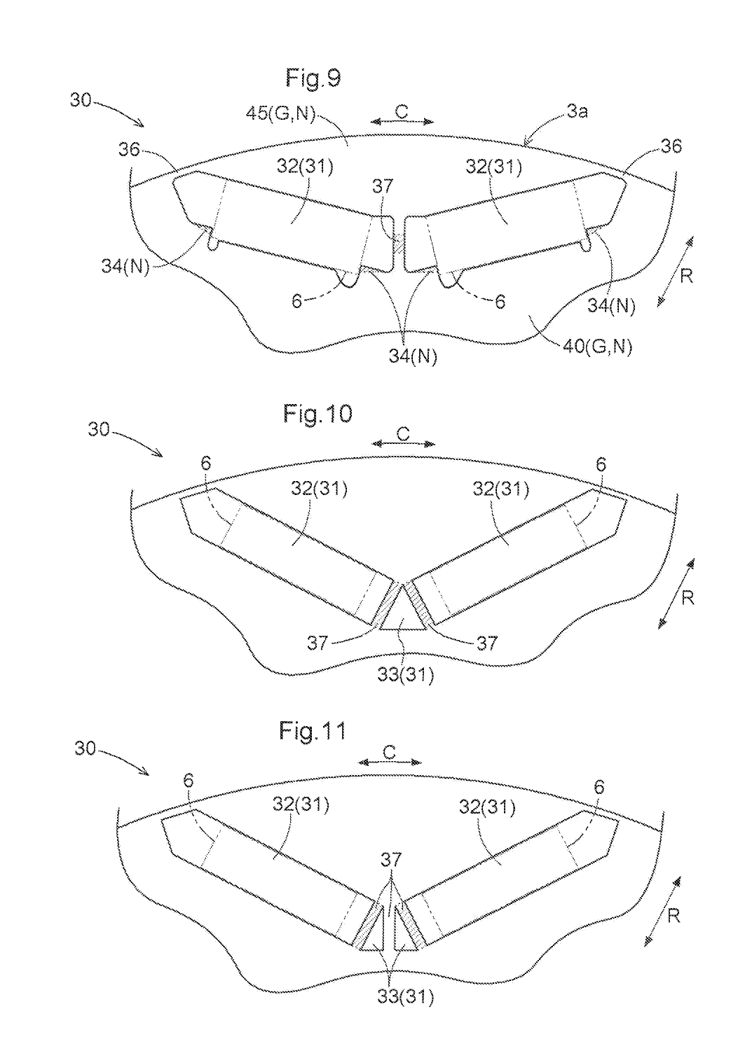

(1) The above embodiment is described with respect to an example in which each of the inter-hole bridge portions 37 entirely has higher hardness (smaller thickness). However, the present disclosure is not limited to this configuration. For example, as shown in FIG. 9, each of the inter-hole bridge portions 37 may partially have higher hardness. The same applies to the positioning protrusions 34. That is, each of the positioning protrusions 34 may partially have higher hardness.

(2) The above embodiment is described with respect to an example in which the electrical steel sheets 30 have only the magnet insertion holes 32 as the holes 31. However, the present disclosure is not limited to this configuration. For example, as shown in FIG. 10, the electrical steel sheets 30 may have magnetic barrier holes 33 in addition to the magnet insertion holes 32. In this case, the holes 31 include both the magnet insertion holes 32 and the magnetic barrier holes 33. The inter-hole bridge portions 37 are formed between each magnet insertion hole 32 (radially inner extended barrier portion 32B) and the magnetic barrier hole 33. For example, in the example of FIG. 11 in which two magnetic barrier holes 33 are formed, the inter-hole bridge portions 37 are formed between each magnet insertion hole 32 (radially inner extended barrier portion 32B) and each magnetic barrier hole 33 and between the magnetic barrier holes 33. The magnetic barrier holes 33 function as magnetic resistance (flux barrier) to magnetic flux flowing in the rotor core 3, separately from the extended barrier portions 32B. The permanent magnets 6 are not inserted in the magnetic barrier holes 33.

(3) The above embodiment is described with respect to an example in which all of the inter-hole bridge portions 37 have higher hardness (and a smaller thickness). However, the present disclosure is not limited to this configuration. For example, as shown in FIG. 11, in the case where a plurality of inter-hole bridge portions 37 are present in each magnetic pole P, only a part of the inter-hole bridge portions 37 may have higher hardness. The same applies to the positioning protrusions 34. Namely, only a part of the positioning protrusions 34 may have higher hardness. In the case where only one inter-hole bridge portion 37 is present in each magnetic pole P as in the above embodiment, only the inter-hole bridge portion(s) 37 included in a part of the magnetic poles P may have higher hardness.

(4) The above embodiment is described with respect to an example in which only the inter-hole bridge portions 37 in the electrical steel sheets 30 in the middle region Rc have higher hardness (and a smaller thickness) and the inter-hole bridge portions 37 in the electrical steel sheets 30 in the first end region Re1 or the second end region Re2 do not have higher hardness (and a smaller thickness). However, the present disclosure is not limited to this configuration. For example, the inter-hole bridge portions 37 in all the electrical steel sheets 30 may have higher hardness regardless of the position of the electrical steel sheet 30 in the axial direction L. The same applies to the positioning protrusions 34. That is, the positioning protrusions 34 in all the electrical steel sheets 30 may have higher hardness.

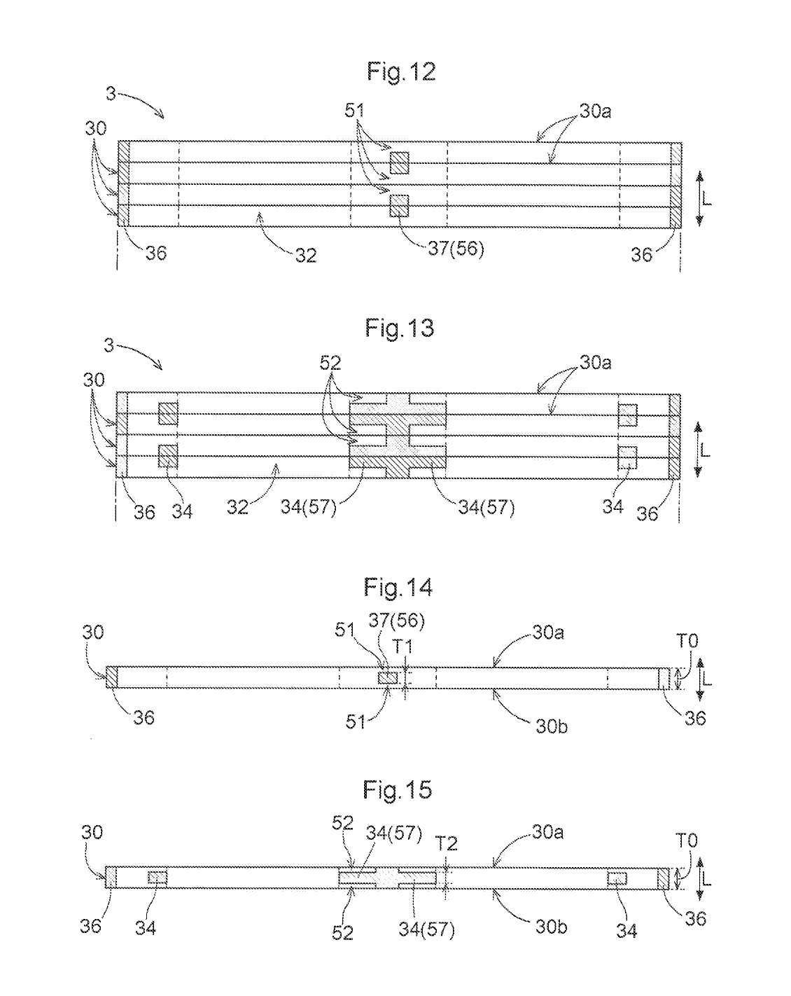

(5) The above embodiment is described with respect to an example in which the electrical steel sheets 30 in the middle region Rc are stacked such that the first recesses 51 and the second recesses 52 face the same side in the axial direction L. However, the present disclosure is not limited to this configuration. For example, as shown in FIGS. 12 and 13, two electrical steel sheets 30 adjoining each other in the axial direction L may be stacked such that the recesses 51, 52 face opposite sides in the axial direction. With this configuration, the inter-hole bridge portions 37 are in back-to-back contact with each other and the positioning protrusions 34 are in back-to-back contact with each other, which increases mechanical strength in these portions. Deformation in these portions is therefore restrained even during, e.g., filling with a resin etc. at a high pressure.

(6) The above embodiment is described with respect to an example in which the inter-hole bridge portions 37 are made harder and thinner by forming the first recesses 51 at predetermined positions in the first principal surface 30a of the electrical steel sheet 30. However, the present disclosure is not limited to this configuration. For example, as shown in FIG. 14, the inter-hole bridge portions 37 may be made thinner by forming the first recesses 51 at predetermined positions in both surfaces (both the first principal surface 30a and a second principal surface 30b) of the electrical steel sheet 30 (e.g., by performing pressing so that both surfaces are recessed). The same applies to the positioning protrusions 34. For example, as shown in FIG. 15, the positioning protrusions 34 may be made thinner by forming the second recesses 52 at predetermined positions in both surfaces (both the first principal surface 30a and the second principal surface 30b) of the electrical steel sheet 30.

(7) The above embodiment is described with respect to an example in which the inter-hole bridge portions 37 and the positioning protrusions 34 are made harder and thinner by performing machining such as pressing on the electrical steel sheet 30. However, the present disclosure is not limited to this configuration. The inter-hole bridge portions 37 and the positioning protrusions 34 may be made harder by performing, e.g., a chemical treatment on the electrical steel sheet 30. In this case, the inter-hole bridge portions 37 and the positioning protrusions 34 may have the same thickness (reference thickness T0) as the general portion G.

(8) The above embodiment is described with respect to an example in which both the inter-hole bridge portions 37 and the positioning protrusions 34 have higher hardness (and a smaller thickness). However, the present disclosure is not limited to this configuration. For example, the inter-hole bridge portions 37 may not have higher hardness and only the positioning protrusions 34 may have higher hardness.

(9) The above embodiment is described with respect to an example in which the permanent magnets 6 have a rectangular sectional shape. However, the present disclosure is not limited to this configuration. The permanent magnets 6 may have any sectional shape such as, e.g., a U-shape, a V-shape, and a semicircular shape. The sectional shape of the magnet insertion holes 32 is determined according to the sectional shape of the permanent magnets 6.

(10) The above embodiment is described mainly with respect to the configuration in which the rotor 1 is an inner rotor that is disposed radially inside a stator. However, the present disclosure is not limited to this configuration. The rotor 1 may be an outer rotor that is disposed radially outside a stator. In this case, inner peripheral bridge portions formed on the stator side (on the radially inner side) have the same hardness as the non-bridge portion N (general portion G) and the inter-hole bridge portions 37 and the positioning protrusions 34 are made harder than the non-bridge portion N (general portion G).

(11) The above embodiment is described with respect to an example in which the technique of the present disclosure is applied to the rotor 1 included in a rotating electrical machine that is used as a driving force source for a vehicle. However, the present disclosure is not limited to this configuration. For example, the technique of the present disclosure is similarly applicable to rotors included in rotating electrical machines that are used for various purposes such as driving an elevator and driving a compressor.

(12) The configurations disclosed in each of the above embodiments (including the embodiment described above and the other embodiments; the same applies to the following description) may be combined with the configurations disclosed in other embodiments unless inconsistency arises. Regarding other configurations as well, the embodiments disclosed in the specification are by way of example only in all respects, and those skilled in the art may make modifications as appropriate without departing from the spirit and scope of the present disclosure.

### Summary of Embodiment

In summary, the rotor according to the present disclosure preferably includes the following configurations.

A rotor (1) includes a rotor core (3) having a plurality of electrical steel sheets (30) stacked in an axial direction (L) and a permanent magnet (6) embedded in the rotor core (3) and is disposed so as to face a stator. The electrical steel sheet (30) has a magnet insertion hole (32) in which the permanent magnet (6) is inserted and a positioning protrusion (34) protruding along a non-pole face (6b) of the permanent magnet (6) into the magnet insertion hole (32), and in at least a part of the plurality of electrical steel sheets (30), the positioning protrusion (34) is harder than a general portion (G) that is a portion other than the positioning protrusion (34).

Inventors' research shows that, in the case where an electrical steel sheet (30) has a positioning protrusion (34) protruding along a non-pole face (6b) of a permanent magnet (6) into a magnet insertion hole (32), the positioning protrusion (34) may also cause leakage flux. Based on this knowledge, magnetic resistance can be increased in the positioning protrusion (34) by making the positioning protrusion (34) harder than the general portion (G), namely the portion other than the positioning protrusion (34), in at least a part of the plurality of electrical steel sheets (30) as described above. Leakage flux is thus reduced and effective magnetic flux is increased, whereby an increase in torque is achieved.

In one aspect, it is preferable that the electrical steel sheet (30) have a magnetic path formation portion (40) extending along a pole face (6a) of the permanent magnet (6), and that the magnetic path formation portion (40) have: a primary magnetic path region (41), that is, a strip-shaped region that has a smallest width portion (41n) having a smallest magnetic path width, the magnetic path width being a width of the magnetic path formation portion (40) in a direction perpendicularly crossing the pole face (6a), and that has the same width as the smallest width portion (41n) and extends along the pole face (6a); and a secondary magnetic path region (42) that is included in a portion having a larger magnetic path width than the smallest width portion (41n) and that is located closer to the magnet insertion hole (32) than the primary magnetic path region (41) is. In addition to the positioning protrusion (34), a part of the secondary magnetic path region (42) is preferably continuous with a base (34b) of the positioning protrusion (34) and harder than the general portion (G), and the primary magnetic path region (41) preferably has the same hardness as the general portion (G).

With this configuration, since the portion having higher hardness extends from the positioning protrusion (34) to at least a part of the secondary magnetic path region (42), leakage flux is further reduced and a further increase in torque is achieved. The primary magnetic path region (41) has the same hardness as the general portion (G). In other words, the primary magnetic path region (41) is not made harder than the general portion (G). Accordingly, magnetic resistance in the primary magnetic path region (41) does not become larger than usual, and magnetic flux flowing along the pole face (6a) of the permanent magnet (6) in the magnetic path formation portion (40) (mainly the primary magnetic path region (41) in this example) is not adversely affected.

In one aspect, it is preferable that the electrical steel sheet (30) further have, as a portion different from the general portion (G), a stator-side bridge portion (36) that is a bridge portion between the magnet insertion hole (32) and a stator opposing surface (3a) of the rotor core (3), and an inter-hole bridge portion (37) that is a bridge portion between two of the magnet insertion holes (32) which are adjacent to each other in a circumferential direction (C), and in at least a part of the plurality of electrical steel sheets (30), the stator-side bridge portion (36) have the same hardness as the general portion (G) and at least a part of a plurality of the inter-hole bridge portions (37) be harder than the general portion (G).

With this configuration, since at least a part of the plurality of the inter-hole bridge portions (37) is made harder than the general portion (G), leakage flux is also reduced in the inter-hole bridge portion (37), and a further increase in torque is achieved. Regarding the outer peripheral bridge portion (36), the outer peripheral bridge portion (36) has the same hardness as the general portion (G). In other words, the outer peripheral bridge portion (36) is not made harder than the general portion (G). Accordingly, no residual stress remains in the stator-side bridge portion (36) located near a stator-side surface of the rotor (1), and hysteresis loss in the stator-side bridge portion (36) does not become greater than usual. An increase in iron loss is thus restrained.

In one aspect, it is preferable that the rotor core (3) be divided into three axial regions, namely a first end region (Re1), a middle region (Rc), and a second end region (Re2) from one side in the axial direction, in the electrical steel sheet (30) in the middle region (Rc), the positioning protrusion (34) be harder than the general portion (G), and in the electrical steel sheet (30) in the first end region (Re1) or the second end region (Re2), the positioning protrusion (34) have the same hardness as the general portion (G).

If the positioning protrusion (34) is made harder than the general portion (G) in the first end region (Re1) and the second end region (Re2) which are located at both axial ends of the rotor core (3), leakage flux flowing through this positioning protrusion (34) is reduced, but leakage flux in the axial direction (L) is increased accordingly. In view of this, as described above, the positioning protrusion (34) is made to have the same hardness as the general portion (G) in the electrical steel sheet (30) in the first end region (Re1) or the second end region (Re2), whereby leakage flux in the axial direction (L) is reduced. The overall effective magnetic flux of the rotor (1) is thus further increased, and a further increase in torque is achieved.

In one aspect, it is preferable that the positioning protrusion (34) that is harder than the general portion (G) be thinner than the general portion (G).

With this configuration, since the positioning protrusion (34) is made thinner than the general portion (G), the magnetic path sectional area is reduced and magnetic resistance is increased in the positioning protrusion (34). This also reduces leakage flux and thus increases effective magnetic flux. A further increase in torque is thus achieved by the increased hardness and reduced thickness of the positioning protrusion (34).

In one aspect, it is preferable that the positioning protrusion (34) that is harder than the general portion (G) be thinner than the general portion (G) because a recess (52) is formed in a surface on one side in the axial direction (L) of the electrical steel sheet (30), and two of the electrical steel sheets (30) which adjoin each other in the axial direction (L) be stacked such that the recesses (52) face opposite sides in the axial direction.

With this configuration, the positioning protrusion (34) that is harder and thinner than the general portion (G) can be easily formed by merely forming the recess (52) at a predetermined position in the surface on one side in the axial direction (L) of each of these electrical steel sheets (30) by, e.g., pressing etc. In this case, the positioning protrusions (34) having a smaller thickness are brought into back-to-back contact with each other by stacking the two electrical steel sheets (30) adjoining each other in the axial direction (L) such that the recesses (52) face opposite sides in the axial direction (L). Accordingly, the continuous thickness of the positioning protrusions (34) in the two electrical steel sheets (30) adjoining each other in the axial direction (L) is larger than in the configuration in which, e.g., two electrical steel sheets (30) adjoining each other in the axial direction (L) are stacked such that the recesses (52) face the same side in the axial direction (L). This increases mechanical strength of the positioning protrusions (34) that are made thinner for increased torque.

In one aspect, it is preferable that the positioning protrusion (34) be a protrusion that protrudes into a region sandwiched between imaginary lines extended from ends of a pair of the pole faces (6a) of the permanent magnet (6) in a tangential direction to each pole face (6a) and that contacts the permanent magnet (6).

With this configuration, the permanent magnet (6) is appropriately positioned in the magnet insertion hole (32) without affecting the flow of magnetic flux entering and leaving the permanent magnet (6) through the pole faces (6).

The rotor according to the present disclosure needs to only have at least one of the above effects.

1-7. (canceled)

8. A rotor that comprising:
a rotor core having a plurality of electrical steel sheets stacked in an axial direction; and
a permanent magnet embedded in the rotor core and disposed so as to face a stator, wherein:
the electrical steel sheet has a magnet insertion hole in which the permanent magnet is inserted and a positioning protrusion protruding along a non-pole face of the permanent magnet into the magnet insertion hole, and
in at least a part of the plurality of electrical steel sheets, the positioning protrusion is harder than a general portion that is a portion other than the positioning protrusion.

9. The rotor according to claim 8, wherein
the electrical steel sheet has a magnetic path formation extending along a pole face of the permanent magnet,
the magnetic path formation has:
a primary magnetic path region, which is a strip-shaped region that has a smallest width portion having a smallest magnetic path width, a magnetic path width being a width of the magnetic path formation in a direction perpendicularly crossing the pole face, and that has a same width as the smallest width portion and extends along the pole face; and
a secondary magnetic path region that is included in a portion having a larger magnetic path width than the smallest width portion and that is located closer to the magnet insertion hole than the primary magnetic path region,
in addition to the positioning protrusion, a part of the secondary magnetic path region is harder than the general portion, the part being continuous with a base of the positioning protrusion, and
the primary magnetic path region has the same hardness as the general portion.

10. The rotor according to claim 8, wherein
the electrical steel sheet further has, as a portion different from the general portion, a stator-side bridge that is a bridge between the magnet insertion hole and a stator opposing surface of the rotor core, and an inter-hole bridge that is a bridge between two of the magnet insertion holes which are adjacent to each other in a circumferential direction, and
in at least a part of the plurality of electrical steel sheets, the stator-side bridge has the same hardness as the general portion and at least a part of a plurality of inter-hole bridge portions is harder than the general portion.

11. The rotor according to claim 9, wherein
the electrical steel sheet further has, as a portion different from the general portion, a stator-side bridge that is a bridge between the magnet insertion hole and a stator opposing surface of the rotor core, and an inter-hole bridge that is a bridge between two of the magnet insertion holes which are adjacent to each other in a circumferential direction, and
in at least a part of the plurality of electrical steel sheets, the stator-side bridge has the same hardness as the general portion and at least a part of a plurality of inter-hole bridge portions is harder than the general portion.

12. The rotor according to claim 8, wherein
the rotor core is divided into three axial regions, namely a first end region, a middle region, and a second end region from one side in the axial direction,
in the electrical steel sheet in the middle region, the positioning protrusion is harder than the general portion, and
in the electrical steel sheet in the first end region or the second end region, the positioning protrusion has the same hardness as the general portion.

13. The rotor according to claim 8, wherein
the positioning protrusion that is harder than the general portion is thinner than the general portion.

14. The rotor according to claim 13, wherein
the positioning protrusion that is harder than the general portion is thinner than the general portion because a recess is formed in a surface on one side in the axial direction of the electrical steel sheet, and
two of the electrical steel sheets which adjoin each other in the axial direction are stacked such that the recesses face opposite sides in the axial direction.

15. The rotor according to claim 8, wherein
the positioning protrusion is a protrusion that protrudes into a region sandwiched between imaginary lines extended from ends of a pair of the pole faces of the permanent magnet in a tangential direction to each pole face and that contacts the permanent magnet.
